(19) United States
(12) Patent Application Publication
(10) Pub. No.: US 2026/0219990 A1
(43) Pub. Date: Jul. 30, 2026

(54) SPARE STORAGE ALLOCATION AND SELECTION ORDER CONTROL

(71) Applicant: Dell Products L.P., Round Rock, TX (US)

(72) Inventors: Geng Han, Beijing (CN); Baote Zhuo, Beijing (CN); Vamsi K. Vankamamidi, Hopkinton, MA (US)

(21) Appl. No.: 19/036,172

(22) Filed: Jan. 24, 2025

(51) Int. Cl. G06F 11/10

(52) U.S. Cl. CPC G06F 11/1088; G06F 11/1084; G06F 11/1092

(57) ABSTRACT

A storage drive having the largest total capacity within a set of storage drives is identified as the prime storage drive. For each virtual RAID group allocated from the set of storage drives, the number of storage slices that is required by each virtual RAID group is allocated to that virtual RAID group. If one of the storage slices that was allocated to the virtual RAID group was allocated from the prime storage drive, a spare storage slice is also allocated to that virtual RAID group. When a storage drive fails, degraded virtual RAID groups are repaired in an order that is based on the number of non-failed storage drives that can be used to repair each degraded virtual RAID group. Non-failed storage drives are selected for allocation of spare storage slices based on how many degraded virtual RAID groups can be repaired using each storage drive.

### TECHNICAL FIELD

This disclosure relates generally to dynamic allocation of spare storage across data storage drives, and more specifically to dynamically allocating spare storage and controlling the order in which units of the spare storage are later selected during recovery from a drive failure.

### BACKGROUND

Data storage systems include one or more physical and/or virtual data storage processors that are made up of hardware and/or software, and that service host I/O requests received from physical and/or virtual host machines (“hosts”). Host I/O requests received by a storage processor specify user data that is written and/or read by the hosts. The storage processor executes software that processes the host I/O requests by performing various data processing tasks to organize and persistently store the user data in non-volatile data storage.

### SUMMARY

In the disclosed technology, a data storage drive having the largest total capacity within a set of data storage drives is identified as the prime data storage drive for the set of data storage drives. Virtual RAID groups are allocated from the set of data storage drives. To allocate each virtual RAID group, the number of storage slices that is required by each virtual RAID group is first allocated to the virtual RAID group. In response to one of the storage slices that was allocated to a virtual RAID group having been allocated from the prime storage drive, an additional spare storage slice is also allocated to that virtual RAID group.

In some embodiments, allocating a spare storage slice to a virtual RAID group includes randomly selecting, from those storage drives within the set of data storage drives other than the storage drives from which storage slices were already allocated to the virtual RAID group, a storage drive for allocation of the spare slice.

In some embodiments, allocating the number of storage slices that is required by each virtual RAID group to a virtual RAID group includes ordering the set of data storage drives in descending order of available capacity, allocating a first storage slice from the first data storage drive in the ordered set of data storage drives, and allocating individual storage slices from subsequent data storage drives in the ordered set of data storage drives until the total number of storage slices that is required by each virtual RAID group has been allocated to the virtual RAID group.

In some embodiments, RAID stripes are allocated from individual ones of the allocated virtual RAID groups.

In some embodiments, the total number of storage slices required by each virtual RAID group is equal to a RAID width of the RAID stripes allocated from the individual ones of the allocated virtual RAID groups.

In some embodiments, a failure of one of the data storage drives causes those virtual RAID groups to which storage slices were allocated from the failed data storage drive to become degraded. In response to the failure of the data storage drive, the degraded virtual RAID groups are repaired at least in part by allocating spare storage slices to the degraded virtual RAID groups based on how many of the non-failed data storage drives in the set of data storage drives can be used to allocate a spare storage slice to each individual one of the degraded virtual RAID groups.

In some embodiments, repairing the degraded virtual RAID groups includes generating a sorted list of the degraded virtual RAID groups. The degraded virtual RAID groups are sorted in ascending order of the number of non-failed data storage drives in the set of data storage drives that can be used to allocate a spare storage slice to repair each degraded virtual RAID group. Spare storage slices are then allocated to individual ones of the degraded virtual RAID groups according to the sorted list of degraded virtual RAID groups.

In some embodiments, repairing each one of the degraded virtual RAID groups includes a) generating a list of storage drives from which a spare storage slice can be allocated to repair the degraded virtual RAID group, b) sorting the list of storage drives according to the total number of degraded virtual RAID groups for which each storage drive can be used to allocate a spare storage slice, and c) selecting, for allocation of a spare storage slice to repair the degraded virtual RAID group, the first storage drive in the sorted list of storage drives.

The disclosed technology is integral to a technical solution to the problem of dynamically distributing spare capacity across multiple data storage drives and controlling the order in which units of spare capacity are later used during recovery from a drive failure. Without the disclosed technology, all virtual RAID groups may need to be pre-allocated, with the total amount of spare capacity being initially reserved on a single one of the data storage drives and then moved throughout the data storage drives. Additionally, without the disclosed technology, selection of units of spare capacity may occur in an improper order during drive failure recovery, potentially resulting in an inability to repair all virtual RAID groups that were degraded as a result of the drive failure.

The foregoing summary does not indicate required elements or otherwise limit the embodiments of the disclosed technology described herein. The technical features described herein can be combined in any specific manner, and all combinations may be used to embody the disclosed technology.

### BRIEF DESCRIPTION OF THE DRAWINGS

The objects, features and advantages of the disclosed technology will be apparent from the following description of embodiments, as illustrated in the accompanying drawings in which like reference numbers refer to the same parts throughout the different views. The drawings are not necessarily to scale, emphasis instead being placed on illustrating the principles of the disclosed technology.

FIG. 1 is a block diagram showing an example of an embodiment of the disclosed technology;

FIG. 2 is a block diagram showing an example of a set of data storage drives, a prime data storage drive, prime virtual RAID groups, and a regular (non-prime) virtual RAID group;

FIG. 3 is a block diagram showing the set of data storage drives from FIG. 2 and illustrates the proportional distribution of required and spare storage capacity after allocation of virtual RAID groups from the set of data storage drives;

FIG. 4 is a flow chart showing steps performed in some embodiments to allocate virtual RAID groups; and

FIG. 5 is a flow chart showing steps performed in some embodiments to repair degraded virtual RAID groups after a failure of a data storage drive.

### DETAILED DESCRIPTION

Embodiments will now be described with reference to the figures. The embodiments described herein are provided only as examples, in order to illustrate various features and principles of the disclosed technology and are not limiting. The embodiments of the disclosed technology described herein are integrated into a practical solution for dynamically distributing spare capacity across multiple data storage drives and controlling the order in which units of spare capacity are subsequently allocated during drive failure recovery.

Embodiments of the disclosed technology provide RAID (Redundant Array of Independent Disks) data storage virtualization/protection technology. The disclosed technology allocates individual virtual RAID groups by combining units of contiguous data storage capacity (referred to as “storage slices”) that are each located on a different physical data storage drive. For example, the total capacity of each physical data storage drive may be divided into fixed sized storage slices. Each storage slice may, for example, consist of four gigabytes of physically contiguous data storage located within a single data storage drive. Other sizes of storage slices may be used in the alternative. Each one of the storage slices that is allocated to any individual virtual RAID group must be located on a different storage drive.

RAID stripes are allocated from individual virtual RAID groups. RAID stripes allocated from a specific virtual RAID group store host data by striping the host data across the storage slices that were allocated to that virtual RAID group. Different RAID levels may be used, depending on required levels of redundancy and performance. Storing received host data into a RAID stripe involves segmenting the received host data into logically sequential blocks (e.g. sequential blocks in an address space of a logical storage object served by the data storage system), and storing data written to consecutive blocks in the logical sequence of blocks onto different ones of the storage slices allocated to the virtual RAID group from which the RAID stripe was allocated, thereby storing logically consecutive blocks of host data onto different data storage drives. By spreading the host data across multiple, different data storage drives that can be accessed concurrently, total data throughput may be increased.

RAID levels that employ “parity” error protection may be used to provide fault tolerance by maintaining one or more parity blocks in each RAID stripe. For example, a parity block for a RAID stripe may be maintained that is the result of performing a bitwise exclusive “OR” (XOR) operation across the data blocks in the stripe. When physical storage for a data block in the RAID stripe fails, e.g. due to a data storage drive failure, the lost data block can be recovered by performing an XOR operation across the remaining data blocks and the parity block.

For example, some embodiments of the disclosed technology use a RAID level that provides block level striping with distributed parity error protection known as 4D+1P (“four data plus one parity”) RAID-5. In 4D+1P RAID-5, each RAID stripe must include 4 data blocks and one block of parity information. In a virtual RAID group from which 4D+1P RAID-5 stripes are allocated, five storage slices from five different storage drives are combined to store the data and parity information, so that each one of the four data blocks and the parity information for each RAID stripe allocated from the allocated from the virtual RAID group is stored on a different storage drive. The RAID width of 4D+1P RAID-5 is 5, and each virtual RAID group supporting 4D+1P RAID-5 level RAID stripes must be allocated 5 storage slices that are located on 5 different storage drives. 4D+1P RAID-5 is generally considered to be effective in preventing data loss in the case of single storage drive failures. The disclosed technology is not limited to use with 4D+1P RAID-5 and may be embodied with other RAID levels having other RAID widths in the alternative.

In addition to the storage space that is allocated to store data blocks and parity information, spare storage space is reserved to handle storage drive failures. In the event one of the storage drives fails, the host data stored on the failed storage drive is rebuilt onto spare storage space by performing XOR operations on the remaining data blocks and the parity information on a per-stripe basis.

As described further herein, a data storage drive having the largest total capacity within a set of data storage drives is identified as the prime data storage drive for the set of data storage drives. Virtual RAID groups are then allocated from the set of data storage drives. For each virtual RAID group that is allocated, the number of storage slices that is required by each virtual RAID group is allocated to the virtual RAID group. In response to detecting that one of the storage slices that was allocated to the virtual RAID group was allocated from the prime storage drive, the disclosed technology also allocates a spare storage slice to the virtual RAID group.

Allocation of a spare storage slice to the virtual RAID group may include randomly selecting a storage drive for allocation of the spare slice from those storage drives within the set of data storage drives other than the storage drives from which storage slices were already allocated to the virtual RAID group.

Allocation of the number of storage slices that is required by each virtual RAID group to a virtual RAID group may include ordering the set of data storage drives in descending order of available capacity, allocating a first storage slice from the first data storage drive in the ordered set of data storage drives, and allocating individual storage slices from subsequent data storage drives in the ordered set of data storage drives until the total number of storage slices that is required by each virtual RAID group has been allocated to the virtual RAID group.

RAID stripes may be allocated from individual ones of the allocated virtual RAID groups. The total number of storage slices required by each virtual RAID group may be equal to the RAID width of the RAID stripes that are allocated from the individual ones of the allocated virtual RAID groups.

A failure of one of the data storage drives causes those virtual RAID groups to which storage slices were allocated from the failed data storage drive to become degraded. In response to the failure of the data storage drive, the degraded virtual RAID groups may be repaired at least in part by allocating a spare storage slice to each of the degraded virtual RAID groups. The order in which the degraded virtual RAID groups are repaired is based on how many of the non-failed data storage drives in the set of data storage drives can be used to allocate a spare storage slice to each individual degraded virtual RAID group.

Repairing the degraded virtual RAID groups may include generating a sorted list of the degraded virtual RAID groups. The degraded virtual RAID groups may be sorted in an ascending order of the number of non-failed data storage drives in the set of data storage drives that can be used to allocate a spare storage slice to repair each degraded virtual RAID group. Spare storage slices are then allocated to individual ones of the degraded virtual RAID groups in the order of virtual RAID groups in the sorted list.

Each one of the degraded virtual RAID groups may be repaired at least in part by a) generating a list of storage drives from which a spare storage slice drive can be allocated to repair the degraded virtual RAID group, b) sorting the list of storage drives according to the total number of degraded virtual RAID groups for which each storage drive can be used to allocate a spare storage slice, and c) selecting, for allocating a spare storage slice to repair the degraded virtual RAID group, the first storage drive in the sorted list of storage drives.

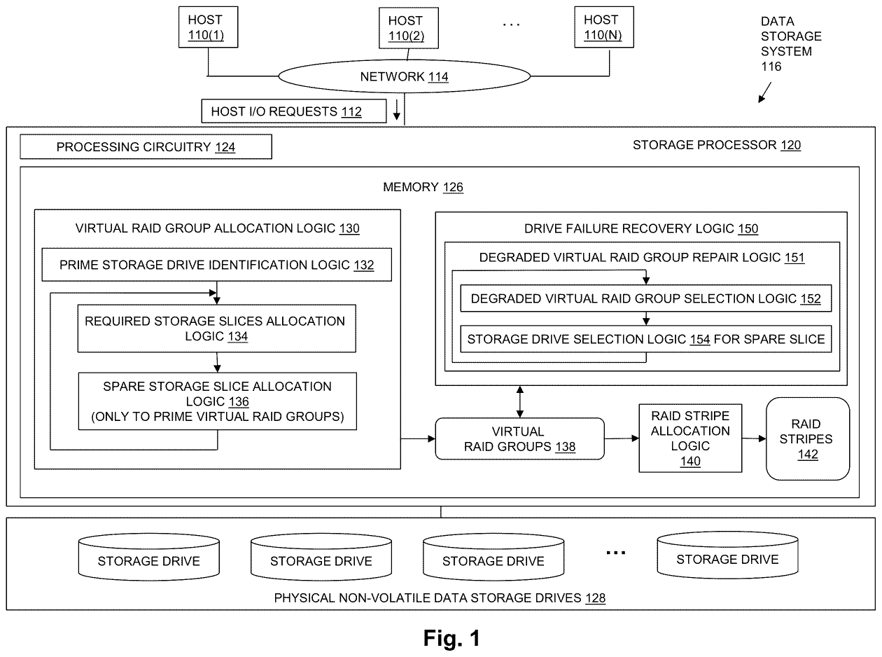

FIG. 1 is a block diagram showing an operational environment for the disclosed technology, including an example of a Data Storage System 116 in which the disclosed technology may be embodied. FIG. 1 shows a number of physical and/or virtual Host Computing Devices 110, referred to as “hosts”, and shown for purposes of illustration by Hosts 110(1) through 110(N). The hosts and/or applications executing thereon access non-volatile data storage provided by Data Storage System 116, for example over one or more networks, such as a local area network (LAN), and/or a wide area network (WAN) such as the Internet, etc., and shown for purposes of illustration in FIG. 1 by Network 114. Alternatively, or in addition, one or more of Hosts 110 and/or applications accessing non-volatile data storage provided by Data Storage System 116 may execute within Data Storage System 116.

Data Storage System 116 includes at least one Storage Processor 120 that is communicably coupled to both Network 114 and Physical Non-Volatile Data Storage Drives 128, e.g. though one or more communication interfaces. No particular hardware configuration is required, and Storage Processor 120 may be embodied as any specific type of device that is capable of processing host input/output (I/O) requests (e.g. I/O read requests and I/O write requests, etc.) and persistently storing host data.

Physical Non-Volatile Data Storage Drives 128 includes physical data storage drives such as solid-state drives, magnetic disk drives, hybrid drives, optical drives, and/or other specific types of drives.

Memory 126 stores program code that is executed on Processing Circuitry 124, as well as data generated and/or processed by such program code. Memory 126 may include volatile memory (e.g. RAM), and/or other types of memory.

Processing Circuitry 124 includes or consists of multiple processor cores, e.g. within one or more multi-core processor packages. Each processor core includes or consists of a separate processing unit, sometimes referred to as a Central Processing Unit (CPU), and is capable of independently executing instructions.

Processing Circuitry 124 and Memory 126 together form control circuitry that is configured and arranged to carry out various methods and functions described herein. Memory 126 stores a variety of software components that may be provided in the form of executable program code. For example, Memory 126 may include software components such as Virtual RAID Group Allocation Logic 130, RAID Stripe Allocation Logic 140, and Drive Failure Recovery Logic 150. When program code stored in Memory 126 is executed by Processing Circuitry 124, Processing Circuitry 124 is caused to carry out the operations of the software components described herein. Although certain software components are shown in the Figures and described herein for purposes of illustration and explanation, those skilled in the art will recognize that Memory 126 may also include various other specific types of software components.

Data Storage System 116 provides one or more data storage services to Hosts 110. Host I/O Requests 112 include at least host I/O write requests that indicate host data that is to be persistently stored by Data Storage System 116 in Physical Non-Volatile Data Storage Drives 128 and host I/O read requests that indicate host data stored by Data Storage System 116 that is to be returned to a requesting host. Examples of data storage protocols that may be supported by Data Storage System 116 include without limitation Fibre Channel (FC), Internet Small Computer Systems Interface (iSCSI), and/or Non-Volatile Memory Express (NVMe) protocols.

During operation of the components shown in FIG. 1, Virtual RAID Group Allocation Logic 130 allocates Virtual RAID Groups 138 from Physical Non-Volatile Data Storage Drives 128. RAID Stripe Allocation Logic 140 then allocates RAID Stripes 142 from Virtual RAID Groups 138. RAID Stripes 142 are used by Data Storage System 116 to store host data received by Data Storage System 116.

For example, when Virtual RAID Group Allocation Logic 130 allocates Virtual RAID Groups 138 from Physical Non-Volatile Data Storage Drives 128, Prime Storage Drive Identification Logic 130 first identifies a data storage drive in Physical Non-Volatile Data Storage Drives 128 that has the largest total capacity of the data storage drives within Physical Non-Volatile Data Storage Drives 128 and labels that data storage drive as the prime storage drive for Physical Non-Volatile Data Storage Drives 128. For each virtual RAID group that is then allocated by Virtual RAID Group Allocation Logic 130, Required Storage Slices Allocation Logic 134 first allocates the number of storage slices that is required by each virtual RAID group to the virtual RAID group. The total number of storage slices required by each virtual RAID group may be equal to the RAID width of the RAID Stripes 142 that are allocated by RAID Stripe Allocation Logic 140 from the individual ones of the Virtual RAID Groups 138. For example, in an embodiment in which RAID Stripes 142 are 4D+1 P RAID- 5 stripes, the RAID width is 5, and the total number of storage slices required by each one of the virtual RAID groups in Virtual RAID Groups 138 is 5, each of which must be located on a different one of the data storage drives in Physical Non-Volatile Data Storage Drives 128.

In some embodiments Required Storage Slice Allocation Logic 134 operates to allocate the total number of storage slices to each virtual RAID group by ordering the data storage drives in Physical Non-Volatile Data Storage Drives 128 in descending order of available capacity, e.g. within a list. A first storage slice is allocated from the first data storage drive in the ordered set of data storage drives, and subsequent storage slices are then allocated from subsequent data storage drives in the ordered set of data storage drives until the total number of storage slices that is required by each virtual RAID group has been allocated to the virtual RAID group.

After the total number of storage slices required by each virtual RAID group has been allocated to a virtual RAID group by Required Storage Slices Allocation Logic 134, Spare Storage Slice Allocation Logic 136 checks whether any one of the storage slices that were allocated by Required Storage Slices Allocation Logic 134 to the virtual RAID group was allocated from the prime storage drive. Each one of the virtual RAID groups in which one of the storage slices allocated by Required Storage Slices Allocation Logic 134 is located on the prime storage drive is referred to herein for purposes of explanation as a “prime virtual RAID group.” In response to detecting that one of the storage slices that was allocated by Required Storage Slices Allocation Logic 134 to a virtual RAID group was allocated from the prime storage drive, Spare Storage Slice Allocation Logic 136 allocates a spare storage slice to that virtual RAID group. The spare storage slice is allocated from a data storage drive other than the data storage drives from which Required Storage Slices Allocation Logic 134 previously allocated the total number of storage slices required by each virtual RAID group to the virtual RAID group. The data storage drives other than the data storage drives from which the total number of storage slices required by each virtual RAID group were allocated are accordingly candidate storage drives from which the spare storage slice can potentially be allocated to a prime virtual RAID group. In some embodiments, the specific one of the candidate storage drives that Spare Storage Allocation Logic 136 uses for allocation of the spare storage slice to a prime virtual RAID group is selected randomly.

A failure of one of the data storage drives in Physical Non-Volatile Data Storage Drives 128 is detected by Drive Failure Recovery Logic 150. The failure of the data storage drive causes those virtual RAID groups to which storage slices were allocated from the failed data storage drive to become degraded. In response to the failure of the data storage drive, Degraded Virtual Raid Group Repair Logic 151 repairs the degraded virtual RAID groups by allocating a spare storage slice to each one of the degraded virtual RAID groups. The order in which the degraded virtual RAID groups are repaired by Degraded Virtual RAID Group Repair Logic 151 is based on how many of the non-failed data storage drives in the set of data storage drives can be used to allocate a spare storage slice to each individual one of the degraded virtual RAID groups. Those degraded virtual RAID groups for which relatively fewer of the non-failed data storage drives can be used to allocate a spare storage slice may be repaired before those degraded virtual RAID groups for which relatively more of the non-failed data storage drives can be used to allocate a spare storage slice. A non-failed data storage drive can only be used to allocate a spare storage slice to a given degraded virtual RAID group if i) that storage drive has at least one spare storage slice available for allocation, and ii) no storage slice allocated to that virtual RAID group is located on that storage drive.

For example, Degraded Virtual RAID Group Selection Logic 152 may operate by generating a sorted list of the degraded virtual RAID groups. Degraded Virtual RAID Group Selection Logic 152 may sort the degraded virtual RAID groups in an ascending order of the number of non-failed data storage drives that can be used to allocate a spare storage slice to repair each one of the degraded virtual RAID groups. Storage Drive Selection Logic 154 may then allocate spare storage slices to individual ones of the degraded virtual RAID groups in the order of the degraded virtual RAID groups provided by the sorted list.

For example, Storage Drive Selection Logic 154 repairs each of the degraded virtual RAID groups by selecting a non-failed storage drive from which to allocate a spare storage slice to the degraded virtual RAID groups in order to replace the storage slice that was located on the failed storage drive. For each degraded virtual RAID group, Storage Drive Selection Logic 154 first generates a list of storage drives from which a spare storage slice drive can be allocated to repair that degraded virtual RAID group, i.e. a list of those non-failed storage drives that have at least one spare storage slice available for allocation, and from which no storage slice was allocated to the virtual RAID group. Storage Drive Selection Logic 154 then sorts the storage drives in the list according to the total number of degraded virtual RAID groups for which each storage drive can be used to allocate a spare storage slice. The total number of degraded virtual RAID groups for which a storage drive can be used to allocate a spare storage slice is the number of degraded virtual RAID groups that include no storage slices allocated from that storage drive. Storage Drive Selection Logic 154 then allocates a spare storage slice from the first storage drive in the sorted list of storage drives to repair the degraded virtual RAID group.

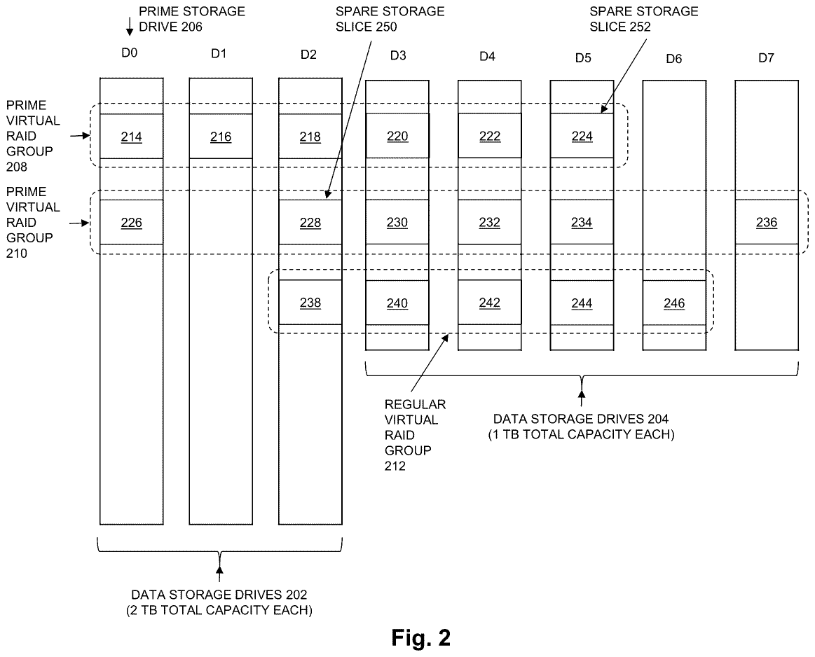

FIG. 2 is a block diagram showing an example of a set of data storage drives including relatively large Data Storage Drives 202, D0, D1, and D2, each of which has 2 terabytes total capacity, and relatively small Data Storage Drives 204, D3, D4, D5, D6 and D7, each of which has 1 terabyte total capacity. One of the relatively large Data Storage Drives 202 is selected as Prime Storage Drive 206, i.e. storage drive D0. Prime Storage Drive 206 may, for example, be selected randomly from within Data Storage Drives 202, since each one of the storage drives in Data Storage Drives 202 has the largest total capacity of the data storage drives in the set of storage drives shown in FIG. 2.

Two prime virtual RAID groups are shown in FIG. 2, e.g. Prime Virtual RAID Group 208 and Prime Virtual RAID Group 210. When Prime Virtual RAID Group 208 is allocated, storage slices 214, 216, 218, 220, and 222 are allocated to Prime Virtual RAID Group 208 by Required Storage Slices Allocation Logic 134. Spare Storage Slice Allocation Logic 136 then detects that storage slice 214 was allocated by Required Storage Slices Allocation Logic 134 from Prime Storage Drive 206. In response to detecting that storage slice 214 was allocated from Prime Storage Drive 206, Spare Storage Slice Allocation Logic 136 randomly selects storage drive D5 from among the candidate storage drives from which a spare storage slice can be allocated to Prime Virtual RAID Group 208, i.e. from among storage drives D5, D6, and D7, and then allocates Spare Storage Slice 252 from storage drive D5 to Prime Virtual RAID Group 208, as shown by storage slice 224 located in storage drive D5.

When Prime Virtual RAID Group 210 is allocated, storage slices 226, 230, 232, 234, and 236 are allocated to Prime Virtual RAID Group 210 by Required Storage Slices Allocation Logic 134. Spare Storage Slice Allocation Logic 136 then detects that storage slice 226 was allocated by Required Storage Slices Allocation Logic 134 from Prime Storage Drive 206. In response to detecting that storage slice 226 was allocated by Required Storage Slices Allocation Logic 134 from Prime Storage Drive 206, Spare Storage Slice Allocation Logic 136 randomly selects storage drive D2 from among the candidate storage drives from which a spare storage slice can be allocated to Prime Virtual RAID Group 210, i.e. from among storage drives D1, D2, and D6, and then allocates Spare Storage Slice 250 from storage drive D2 to Prime Virtual RAID Group 210, as shown by storage slice 228 located in storage drive D2.

One non-prime “regular” virtual RAID group is shown in FIG. 2, e.g. Regular Virtual RAID Group 212. When Regular Virtual RAID Group 212 is allocated, storage slices 238, 240, 242, 244, and 246 are allocated to Regular Virtual RAID Group 212 by Required Storage Slices Allocation Logic 134. Spare Storage Slice Allocation Logic 136 then detects that none of the storage slices allocated by Required Storage Slices Allocation Logic 134 are located in Prime Storage Drive 206. In response to detecting that no storage slice was allocated to Regular Virtual RAID Group 212 from Prime Storage Drive 206, Spare Storage Slice Allocation Logic 136 allocates no spare storage slice to Regular Virtual RAID Group 212.

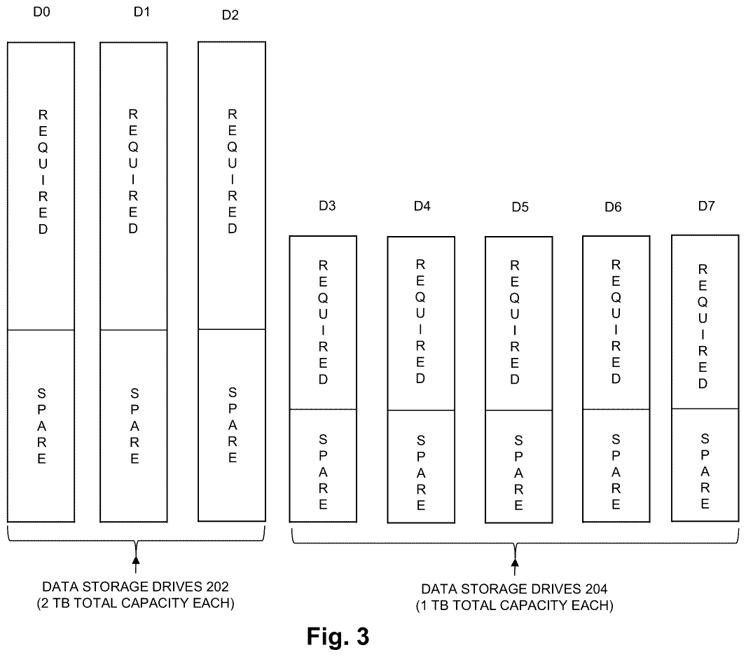

FIG. 3 is a block diagram showing the set of data storage drives from FIG. 2 and illustrates the proportional allocation of required and spare storage capacity across the Data Storage Drives 202 and Data Storage Drives 204 resulting from allocation of virtual RAID groups using the disclosed technology until the total storage capacities of all the data storage drives in the set of data storage drives have been completely consumed.

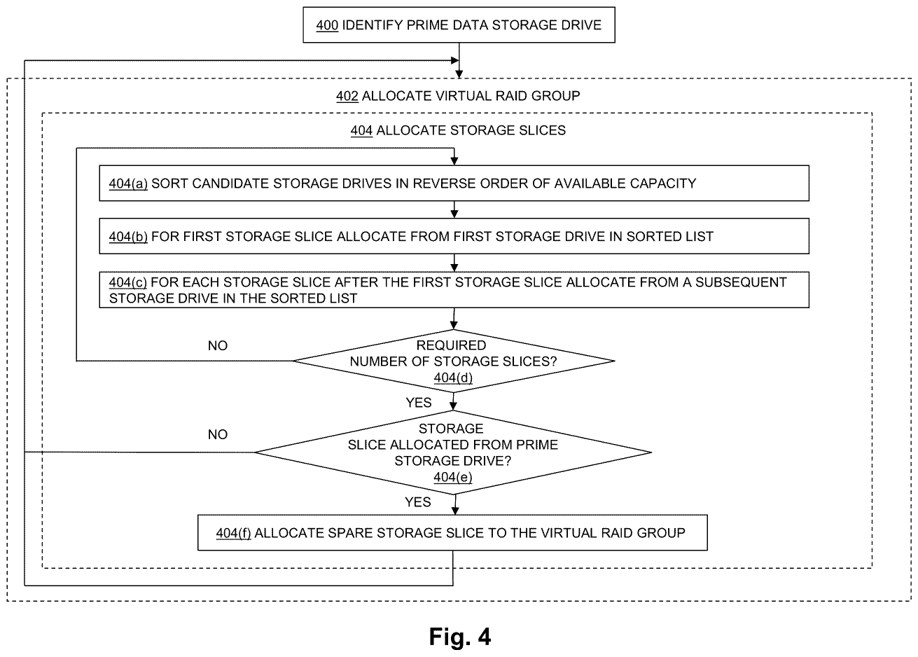

FIG. 4 is a flow chart showing steps performed in some embodiments to allocate virtual RAID groups. In step 400, a drive having the largest total capacity within a set of data storage drives is identified as the prime data storage drive for the set of data storage drives. At step 402, a virtual RAID group is allocated from the set of data storage drives. Step 402 may be repeated until the capacities of all the storage drives in the set have been consumed.

In step 404, storage slices are allocated to the virtual RAID group. Steps 404(a) through 404(c) allocate a single required storage slice to the virtual RAID group. At step 404(a), a sorted list of candidate storage drives for allocation of a storage slice to the virtual RAID group is generated in which the candidate storage drives are listed in descending order of available capacity. The candidate storage drives for allocation of a storage slice to the virtual RAID group are those storage drives within the set i) that have at least one storage slice available for allocation, and ii) from which a storage slice has not previously been allocated to the virtual RAID group. At step 404(b), which is performed in the case of the first storage slice that is allocated to the virtual RAID group, a storage slice is allocated from the storage drive that is first in the list generated at step 404(a). In step 404(c), which is performed in the case of allocating each storage slice after the first storage slice, a storage slice is allocated to the virtual RAID group from a storage drive located following the first storage drive in the sorted list, i.e. from a storage having the highest available capacity of those storage drives from which a storage slice has not yet been allocated to the virtual RAID group. In some embodiments, when allocating a storage slice in step 404(c), a storage drive is selected for allocation from within multiple storage drives all having the highest available capacity by selecting a storage drive from which the fewest number of slices have previously been allocated to previously allocated virtual RAID groups that also contain storage slices located on storage drives from which slices have previously been allocated to the virtual RAID group currently being allocated.

In step 404(d), the disclosed technology detects whether the number of storage slices allocated to the virtual RAID group is equal to the number of storage slices that is required to be allocated to each virtual RAID group. If so, then step 404(d) is followed by step 404(e). Otherwise, step 404(d) is followed by step 404(a). For example, in the case where 4D+1P RAID-5 stripes are to be allocated from the virtual RAID groups being allocated, having a RAID width of 5, the number of storage slices that is required to be allocated to each virtual RAID group is 5.

At step 404(e), the disclosed technology detects whether any one of the storage slices allocated to the virtual RAID group in steps 404(a) through 404(c) was allocated from the prime storage drive. If so, the virtual RAID group is a prime virtual RAID group, and step 404(e) is followed by step 404(f). Otherwise, the virtual RAID group is a non-prime “regular” virtual RAID group, and after step 404(e) the disclosed technology continues to allocate virtual RAID groups by repeating step 402 until the capacities of all the storage drives in the set have been consumed such that no further virtual RAID groups can be allocated.

In step 404(f), the disclosed technology allocates a spare storage slice to the virtual RAID group being allocated. For example, a spare storage slice may be allocated to the virtual RAID group by randomly selecting a storage drive for allocation of the spare slice from those storage drives within the set of data storage drives other than the storage drives from which storage slices were already allocated to the virtual RAID group in steps 404(a) through 404(c).

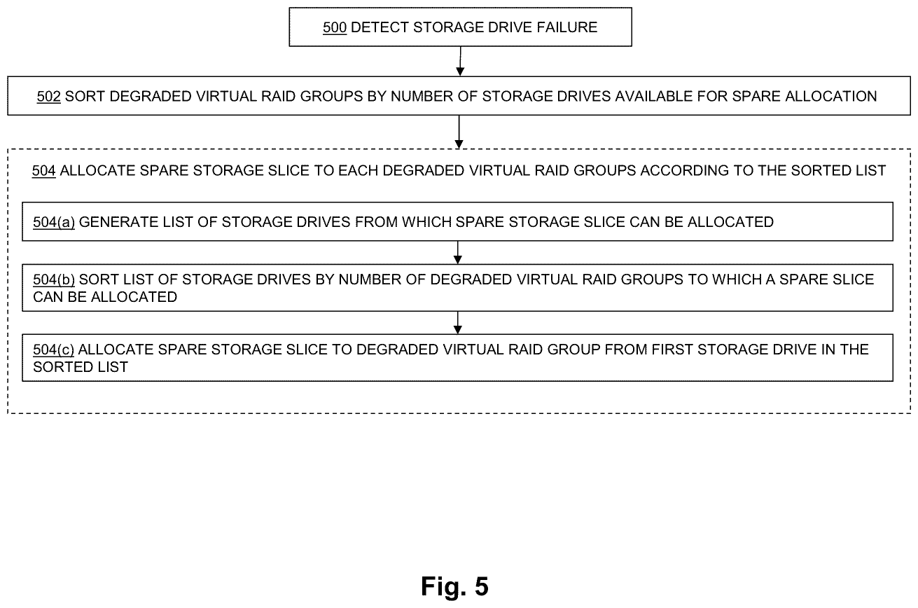

FIG. 5 is a flow chart showing steps performed in some embodiments to repair degraded virtual RAID groups after a failure of a data storage drive.

In step 500, the disclosed technology detects a failure of a storage drive. In response to detecting the storage drive failure at step 500, at step 502 the virtual RAID groups that are degraded as a result of the storage drive failure are sorted in a list according to the number of storage drives that can be used to allocate a spare storage slice to each degraded virtual RAID group. The degraded virtual RAID groups are those virtual RAID groups are those virtual RAID groups to which a storage slice was previously allocated from the failed storage drive. The number of storage drives that can be used to allocate a spare storage slice to a given one of the degraded virtual RAID groups is the number of individual storage drives that both i) have at least one storage slice available for allocation and ii) from which no storage slice has previously been allocated to that virtual RAID group.

In step 504, the degraded virtual RAID groups are repaired by allocating a spare storage slice to each one of the degraded virtual RAID groups, in order to replace the storage slices located on the failed storage drive. The order in which the degraded virtual RAID groups are repaired is the order in which they are listed in the sorted list of degraded virtual RAID groups generated in step 502. Steps 504(a) through 504(c) are performed for each one of the degraded virtual RAID groups.

At step 504(a), a list is generated of all the storage drives from which a storage slice can be allocated to the virtual RAID group being repaired. A storage slice can be allocated from a storage drive to repair the virtual RAID group being repaired if i) the storage drive includes at least one spare drive that is available for allocation, and ii) no storage slice has previously been allocated to the virtual RAID group from the storage drive.

At step 504(b), the list of storage drives generated at step 504(a) is sorted in ascending order of the number of degraded virtual RAID groups that can be repaired by each storage drive. The number of degraded virtual RAID groups that can be repaired by a given storage drive that has at least one spare storage slice available for allocation is the number of degraded virtual RAID groups to which no storage slice has previously been allocated from that storage drive. In step 504(c), a spare storage slice is allocated to the degraded virtual RAID group from the storage drive that is located first in the sorted list resulting from the sorting performed at step 504(b).

Steps 504(a) through 504(c) are repeated until all virtual RAID groups that were degraded as a result of the drive failure have been repaired.

As will be appreciated by those skilled in the art, aspects of the technologies disclosed herein may be embodied as a system, method or computer program product. Accordingly, each specific aspect of the present disclosure may be embodied using hardware, software (including firmware, resident software, micro-code, etc.) or a combination of software and hardware. Furthermore, aspects of the technologies disclosed herein may take the form of a computer program product embodied in one or more non-transitory computer readable storage medium(s) having computer readable program code stored thereon for causing a processor and/or computer system to carry out those aspects of the present disclosure.

Any combination of one or more computer readable storage medium(s) may be utilized. The computer readable storage medium may be, for example, but not limited to, a portable computer diskette, a hard disk, a random-access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any non-transitory tangible medium that can contain or store a program for use by or in connection with an instruction execution system, apparatus, or device.

The figures include block diagram and flowchart illustrations of methods, apparatus(s) and computer program products according to one or more embodiments of the invention. It will be understood that each block in such figures, and combinations of these blocks, can be implemented by computer program instructions. These computer program instructions may be executed on processing circuitry to form specialized hardware. These computer program instructions may further be loaded onto programmable data processing apparatus to produce a machine, such that the instructions which execute on the programmable data processing apparatus create means for implementing the functions specified in the block or blocks. These computer program instructions may also be stored in a computer-readable memory that can direct a programmable data processing apparatus to function in a particular manner, such that the instructions stored in the computer-readable memory produce an article of manufacture including instruction means which implement the function specified in the block or blocks. The computer program instructions may also be loaded onto a programmable data processing apparatus to cause a series of operational steps to be performed on the programmable apparatus to produce a computer implemented process such that the instructions which execute on the programmable apparatus provide steps for implementing the functions specified in the block or blocks.

Those skilled in the art should also readily appreciate that programs defining the functions of the present invention can be delivered to a computer in many forms; including, but not limited to: (a) information permanently stored on non-writable storage media (e.g. read only memory devices within a computer such as ROM or CD-ROM disks readable by a computer I/O attachment); or (b) information alterably stored on writable storage media (e.g. floppy disks and hard drives).

While the invention is described through the above exemplary embodiments, it will be understood by those of ordinary skill in the art that modification to and variation of the illustrated embodiments may be made without departing from the inventive concepts herein disclosed.

What is claimed is:

1. A method comprising:
within a set of data storage drives, identifying a prime data storage drive having a largest total capacity of the data storage drives in the set;
allocating virtual RAID groups from the set of data storage drives by, for each virtual RAID group:
allocating the number of storage slices that is required by each virtual RAID group to the virtual RAID group, and
in response to one of the storage slices allocated to the virtual RAID group having been allocated from the prime storage drive, allocating a spare storage slice to the virtual RAID group.

2. The method of claim 1, wherein allocating the spare storage slice to the virtual RAID group comprises randomly selecting a storage drive for allocation of the spare slice from those storage drives within the set of data storage drives other than the storage drives from which storage slices were already allocated to the virtual RAID group.

3. The method of claim 2, wherein allocating the number of storage slices that is required by each virtual RAID group to the virtual RAID group comprises:
ordering the set of data storage drives in descending order of available capacity;
allocating a first storage slice from the first data storage drive in the ordered set of data storage drives; and
allocating individual storage slices from subsequent data storage drives in the ordered set of data storage drives until the total number of storage slices that is required by each virtual RAID group has been allocated to the virtual RAID group.

4. The method of claim 3, further comprising allocating RAID stripes from individual ones of the allocated virtual RAID groups.

5. The method of claim 4, wherein the total number of storage slices required by each virtual RAID group is equal to a RAID width of the RAID stripes allocated from the individual ones of the allocated virtual RAID groups.

6. The method of claim 5, wherein a failure of one of the data storage drives causes those virtual RAID groups to which storage slices were allocated from the failed data storage drive to become degraded, and further comprising, in response to the failure of the data storage drive, repairing the degraded virtual RAID groups by allocating spare storage slices to the degraded virtual RAID groups based on how many of the non-failed data storage drives in the set of data storage drives can be used to allocate a spare storage slice to the degraded virtual RAID groups.

7. The method of claim 6, wherein repairing the degraded virtual RAID groups further comprises:
generating a sorted list of the degraded virtual RAID groups in ascending order of the number of non-failed data storage drives in the set of data storage drives that can be used to allocate a spare storage slice to repair each degraded virtual RAID group; and
allocating a spare storage slice to each one of the degraded virtual RAID groups in an order according to the sorted list of the degraded virtual RAID groups.

8. The method of claim 7, wherein repairing each one of the degraded virtual RAID groups further comprises a) generating a list of storage drives from which a spare storage slice drive can be allocated to repair the degraded virtual RAID group, b) sorting the list of storage drives according to the total number of degraded virtual RAID groups for which each storage drive can be used to allocate a spare storage slice, and c) selecting, for allocating a spare storage slice to repair the degraded virtual RAID group, the first storage drive in the sorted list of storage drives.

9. A data storage system comprising:
processing circuitry;
a set of data storage drives; and
memory coupled to the processing circuitry and the data storage drives, the memory storing instructions, wherein the instructions, when executed by the processing circuitry, cause the processing circuitry to:
within the set of data storage drives, identify a prime data storage drive having a largest total capacity of the data storage drives in the set;
allocate virtual RAID groups from the set of data storage drives by, for each virtual RAID group, causing the processing circuitry to:
allocate the number of storage slices that is required by each virtual RAID group to the virtual RAID group, and
in response to one of the storage slices allocated to the virtual RAID group having been allocated from the prime storage drive, allocate a spare storage slice to the virtual RAID group.

10. The data storage system of claim 9, wherein causing the processing circuitry to allocate the spare storage slice to the virtual RAID group includes causing the processing circuitry to randomly select a storage drive for allocation of the spare slice from those storage drives within the set of data storage drives other than the storage drives from which storage slices were already allocated to the virtual RAID group.

11. The data storage system of claim 10, wherein causing the processing circuity to allocate the number of storage slices that is required by each virtual RAID group to the virtual RAID group includes causing the processing circuitry to:
order the set of data storage drives in descending order of available capacity;
allocate a first storage slice from the first data storage drive in the ordered set of data storage drives; and
allocate individual storage slices from subsequent data storage drives in the ordered set of data storage drives until the total number of storage slices that is required by each virtual RAID group has been allocated to the virtual RAID group.

12. The data storage system of claim 11, wherein the instructions, when executed by the processing circuitry, further cause the processing circuitry to allocate RAID stripes from individual ones of the allocated virtual RAID groups.

13. The data storage system of claim 12, wherein the total number of storage slices required by each virtual RAID group is equal to a RAID width of the RAID stripes allocated from the individual ones of the allocated virtual RAID groups.

14. The data storage system of claim 13, wherein a failure of one of the data storage drives causes those virtual RAID groups to which storage slices were allocated from the failed data storage drive to become degraded, and wherein the instructions, when executed by the processing circuitry, further cause the processing circuitry to, in response to the failure of the data storage drive, repair the degraded virtual RAID groups by allocating spare storage slices to the degraded virtual RAID groups based on how many of the non-failed data storage drives in the set of data storage drives can be used to allocate a spare storage slice to the degraded virtual RAID groups.

15. The data storage system of claim 14, wherein causing the processing circuitry to repair the degraded virtual RAID groups includes causing the processing circuitry to:
generate a sorted list of the degraded virtual RAID groups in ascending order of the number of non-failed data storage drives in the set of data storage drives that can be used to allocate a spare storage slice to repair each degraded virtual RAID group; and
allocate a spare storage slice to each individual one of the degraded virtual RAID groups in an order according to the sorted list of the degraded virtual RAID groups.

16. The data storage system of claim 15, wherein causing the processing circuitry to repair each one of the degraded virtual RAID groups further comprises causing the processing circuitry to a) generate a list of storage drives from which a spare storage slice drive can be allocated to repair the degraded virtual RAID group, b) sort the list of storage drives according to the total number of degraded virtual RAID groups for which each storage drive can be used to allocate a spare storage slice, and c) select, for allocation of a spare storage slice to repair the degraded virtual RAID group, the first storage drive in the sorted list of storage drives.

17. A computer program product including a non-transitory computer readable medium having instructions stored thereon, wherein the instructions, when executed on processing circuitry, cause the processing circuitry to perform steps including:
within a set of data storage drives, identifying a prime data storage drive having a largest total capacity of the data storage drives in the set;
allocating virtual RAID groups from the set of data storage drives by, for each virtual RAID group:
allocating the number of storage slices that is required by each virtual RAID group to the virtual RAID group, and
in response to one of the storage slices allocated to the virtual RAID group having been allocated from the prime storage drive, allocating a spare storage slice to the virtual RAID group.

18. The computer program product of claim 17, wherein allocating the spare storage slice to the virtual RAID group comprises randomly selecting a storage drive for allocation of the spare slice from those storage drives within the set of data storage drives other than the storage drives from which storage slices were already allocated to the virtual RAID group.

19. The computer program product of claim 18, wherein allocating the number of storage slices that is required by each virtual RAID group to the virtual RAID group comprises:
ordering the set of data storage drives in descending order of available capacity;
allocating a first storage slice from the first data storage drive in the ordered set of data storage drives; and
allocating individual storage slices from subsequent data storage drives in the ordered set of data storage drives until the total number of storage slices that is required by each virtual RAID group has been allocated to the virtual RAID group.

20. The computer program product of claim 19, wherein the steps further comprise allocating RAID stripes from individual ones of the allocated virtual RAID groups, and wherein the total number of storage slices required by each virtual RAID group is equal to a RAID width of the RAID stripes allocated from the individual ones of the allocated virtual RAID groups.
